(19) United States
(12) Patent Application Publication
(10) Pub. No.: US 2005/0198255 A1
(43) Pub. Date: Sep. 8, 2005

(54) Value reporting using web services

(75) Inventors: Barrett G. Wainscott JR., Waukesha, WI (US); Donald A. Gottschalk, Wauwatosa, WI (US)

Correspondence Address: FOLEY & LARDNER, 777 EAST WISCONSIN AVENUE, SUITE 3800, MILWAUKEE, WI, 53202-5308, US

(73) Assignee: Johnson Controls Technology Company

(21) Appl. No.: 10/744,906

(22) Filed: Dec. 23, 2003

(51) Int. Cl. G06F 15/173

(52) U.S. Cl. 709/224

(57) ABSTRACT

A method and apparatus for reporting a change in value over a network using web services is disclosed. The method and apparatus comprise receiving at a notification server a request from a client for information including a change of value, processing the request for information, and reporting the change in value to the client using an event mechanism.

### BACKGROUND

The present invention relates generally to the field of web services. More specifically, the invention relates to the field of value reporting to a client using web services.

Web services are typically implemented using Hyper Text Transfer Protocol (HTTP). HTTP is an Internet standard application-level protocol for distributed information systems. HTTP is often used to transfer user interface information, such as HTML pages, between web servers and web browsers. It is a generic, stateless protocol that can be used for many tasks beyond its use for hypertext, such as name servers and distributed object requests. HTTP is a request-response protocol that usually takes place over a TCP/IP (transmission control protocol/internet protocol) connection. HTTP can take place between a “client” (requester of data) and a “server” (provider of data).

Using HTTP, the typical method of refreshing a screen of values is to implement some polling algorithm at a client location or machine. However, using this method can place a heavy burden on the client's server, especially where a large number of requests must be processed (e.g., when poll rates are high enough to produce acceptable client value updates). In addition, distributed building automation systems do not always have a single point where all of the requested system values are collected. In these situations, each HTTP request for data is directed to the control device that contains the source value. This results in additional delay for a client while the messages are routed and processed. It can also result in a burden on the less capable control devices which must respond directly to each client poll request.

Accordingly, it would be advantageous to provide a transparent mechanism for clients to receive updated values in a timely manner. It would further be advantageous for clients, using web services over HTTP, to be able to update user interfaces quickly or initiate control sequences based on the change in value without placing heavy burdens on servers and control devices. It would further be advantageous to isolate the client requests for data from the control network. It would further be advantageous to provide a building automation system with a single point where all the requested system values are collected utilizing only web services.

It would be advantageous to provide an apparatus or method or the like of a type disclosed in the present application that provides any one or more of these or other advantageous features.

### SUMMARY

One embodiment of the invention relates to a method for reporting a change in value over a network using web services. The method comprises receiving at a notification server a request from a client for information including a change of value, processing the request for information, and reporting the change in value to the client using an event mechanism.

Another embodiment of the invention relates to a method for reporting a change in value using web services. The method comprises receiving a request from a client for information from a controller including a change in value, processing the request for information, and reporting a change in value to the client. A server utilizes web services that are implemented by HTTP to send and receive the information between the client and the controller, the server comprising notification services, a notification database, and a notification management subsystem.

Another embodiment of the present invention relates to an apparatus for reporting a change in value over a network using web services. The apparatus comprises a notification server configured to receive a request from a client for information including a change in value, and at least one controller coupled to the notification server by way of a network. The notification server is further configured to process the request for information and report the change in value to the client. The notification server can utilize web services that are implemented by HTTP to send and receive the information between the client and the controller.

The present invention further relates to various features and combinations of features shown and described in the disclosed embodiments. Other ways in which the objects and features of the disclosed embodiments are accomplished will be described in the following specification or will become apparent to those skilled in the art after they have read this specification. Such other ways are deemed to fall within the scope of the disclosed embodiments if they fall within the scope of the claims which follow.

### BRIEF DESCRIPTION OF THE DRAWINGS

FIG. 1 is a schematic representation of a conventional system for reporting updates in data.

FIG. 2 is a schematic representation of a system for change of value reporting using web services according to an exemplary embodiment.

FIG. 3 is a block diagram of a system for change of value reporting using web services according to an exemplary embodiment.

### DETAILED DESCRIPTION OF EXEMPLARY EMBODIMENTS

Before explaining a number of preferred, exemplary, and alternative embodiments of the invention in detail, it is to be understood that the invention is not limited to the details of construction and the arrangement of the components set forth in the following description or illustrated in the drawings. The invention is capable of other embodiments or being practiced or carried out in various ways. It is also to be understood that the phraseology and terminology employed herein is for the purpose of description and should not be regarded as limiting.

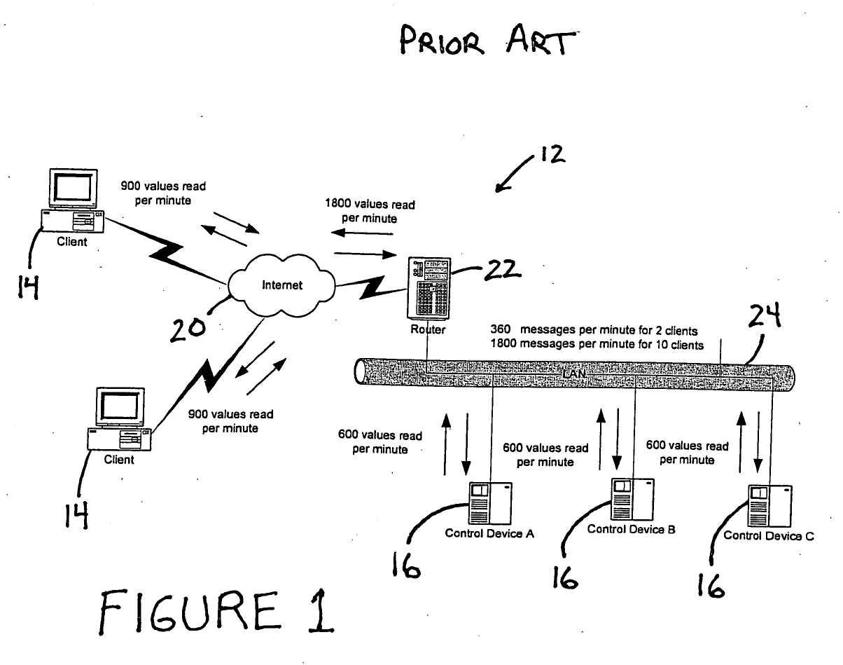

Referring to FIG. 1, a conventional system 12 for reporting updates in data is shown. In general, conventional systems often utilize proprietary communication protocols for transmission of changed values to clients. Each client indicates an interest in a value to a controller and the controller then in turn sends the changed values to the client. This type of system can have various drawbacks. For example, it may not scale well, it can require proprietary protocols, and it can require controller resources for managing subscriptions.

According to the illustrated embodiment, a conventional system 12 is provided wherein each client 14 displays 10 dynamic values from each of three control devices 16 and the values change every 15 seconds. Clients 14 “poll” for data by sending a request to read a value. The clients 14 poll for data by sending a request to read over network 20 (shown as the Internet) to a router 22. Router 22 is connected to local area network (LAN) 24 of a building automation system (BAS) in communication with control devices 16. According to system 12, clients 14 poll for data every two seconds by sending a request to each device 16 through router 22 over LAN 24 to read every value of the devices 16. This results in 30 messages sent to and 30 reply messages from each device in order to read 10 values every minute for each client. For system 12, this equals 360 messages and 1800 values read per minute for two clients 14. This places a heavy burden on the server to process the requests in order to meet client demand. Another problem with the conventional system 12 is that there is not a central point where all of the system values are collected. This is because the requests for data are directed to the control devices 16. This results in additional burden on less capable control devices which must respond directly to each client poll request.

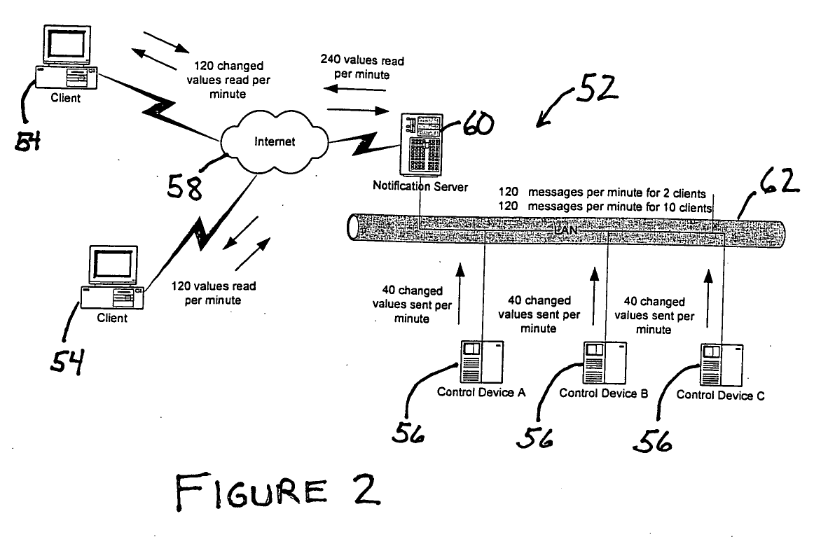

FIG. 2 shows a system 52 for change of value reporting using web services according to an exemplary embodiment. In general, the system provides a scalable implementation of value reporting which utilizes only web services. It provides for the ability for many simultaneous clients to rapidly update data values without placing undue hardship on servers or controllers. According to exemplary embodiments, the clients are browser based applications which utilize web services to request data in a polled manner from the server. The poll rate of the client is dynamically adjusted based on the current server load. The polls are limited to the servers because the server includes the relevant data (e.g., the server provides a central repository for a subset of all the real time data contained in the system). Accordingly, the poll rate can be increased to provide the desired response time (without placing undue burdens on the server) because each call is a local database request and the requests do not affect the network or control devices. For example, the clients can initiate a read request for a value to a server. The server then transparently interprets the read request as the need to continually keep the value refreshed in a local database. Based on the request, control devices asynchronously report back to the server using web services to report any changes in value. All future requests for that value can then be returned from the server to the clients without any control device interaction.

According to an exemplary embodiment, system 52 is provided wherein each client 54 displays 10 dynamic values from each of three control devices 56 and the values change every 15 seconds. Clients 54 “poll” for data by sending a request to read a value. The clients 54 poll for data by sending a request to read over network 58 (shown as the Internet) to a notification server 60. Notification server 60 is connected to local area network (LAN) 62 in communication with control devices 56. According to system 52, clients 54 poll for data every two seconds. The request is processed by the notification server 60 which utilizes an event mechanism that requests only changes in values be sent back to the clients 54. Where there are four changes per minute per value (for ten values), the traffic on LAN 62 is 120 messages per minute (regardless of the number of clients). As compared to system 12 shown in FIG. 1, system 52 produces significantly less traffic over networks 58 and 62. System 52 allows clients 54 to indicate an interest in the change of a value and then be notified when that change occurs.

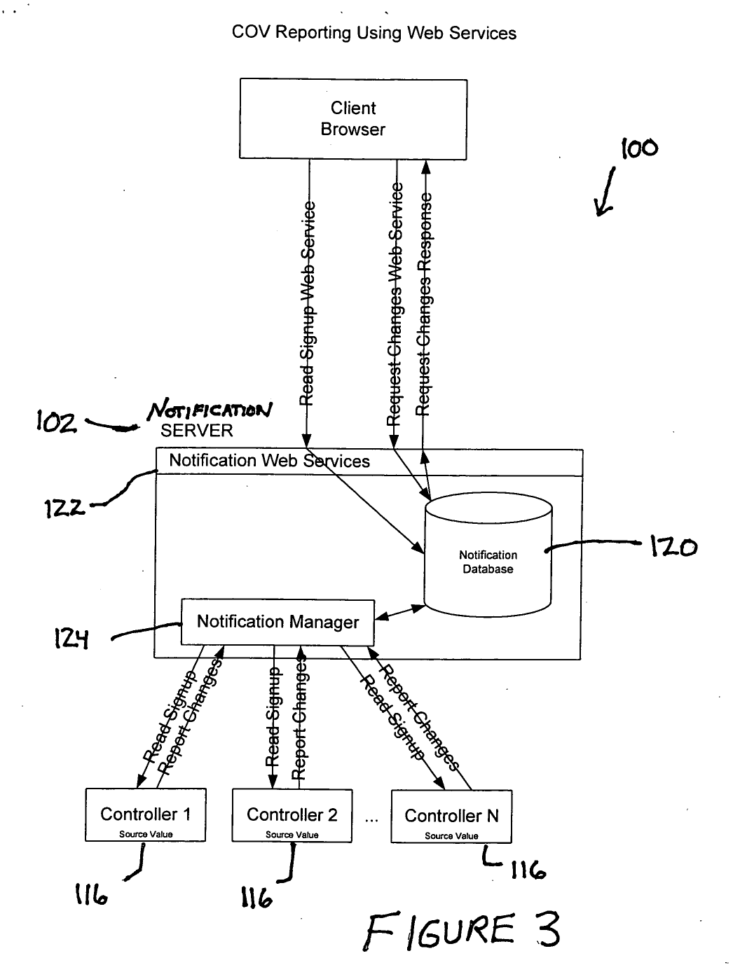

Referring to FIG. 3 a diagram of a system for change of value reporting using web services is shown according to an exemplary embodiment. FIG. 3 shows a notification server 102 including a notification database 120 configured to provide notification services 122 and a notification management subsystem 124. According to an exemplary embodiment, notification database 120 is a relational database that tracks the following information: (a) current values as reported from the source values in the controllers, (b) a list of clients and which values each is interested in, (c) the last values reported to each client, and (d) the last time a client requested changed values.

According to an exemplary embodiment, notification services 122 are web services that are utilized by the server to sign-up for notification and to request changed values from the end devices. A read service request from the client adds entries to the relational database. This provides for transparent operation from the client. The server then uses notification services 122 on the control devices to request asynchronous updates for the data values. The read service request executes a structured query language (SQL) query against the relational database to retrieve changed values and format them for return to the client. Since the read service request is reduced to a local database call, the server side processing is minimal which enables the poll rate on the client to be reduced without placing an undue load on the server. Along with the data that is returned to the client is a poll rate adjustment for the client. Based on current server resource usage, the server will notify the client to poll faster, poll slower, or remain unchanged.

Notification management subsystem 124 detects additions to the database that represent new clients or new sign-ups. As new clients request data from the server, a new entry is added to the database and the server initiates sign-up requests to the control devices. Notification management subsystem 124 also provides an algorithm for removing “dead” (e.g., unused, timed out, etc.) clients and their respective sign-ups from the database tables. After a predefined period of time in which no read requests are received from a client, the server removes the entries from the database and notifies the devices via a sign off request that there is no longer an interest in the value. Notification management subsystem 124 is responsible for utilizing underlying system services to keep data values updated in database 120 for use by notification services 122.

Controllers 116 provide source values for various devices located at a client location. According to an exemplary embodiment, the controllers may include a supervisory controller or a LAN based unitary controller, etc. According to alternative embodiments, controllers 116 may include additional and/or other controllers.

It is important to note that the above-described preferred embodiments are illustrative only. Although the invention has been described in conjunction with specific embodiments thereof, those skilled in the art will appreciate that numerous modifications are possible without materially departing from the novel teachings and advantages of the subject matter described herein. For example, poll rates may be varied, the configuration of notification server may be adjusted, various control devices and clients may be utilized, etc. Accordingly, these and all other such modifications are intended to be included within the scope of the present invention as defined in the appended claims. The order or sequence of any process or method steps may be varied or re-sequenced according to alternative embodiments. In the claims, any means-plus-function clause is intended to cover the structures described herein as performing the recited function and not only structural equivalents but also equivalent structures. Other substitutions, modifications, changes and omissions may be made in the design, operating conditions and arrangements of the preferred and other exemplary embodiments without departing from the spirit of the present invention.

1. A method for reporting a change in value over a network using web services, comprising:
receiving at a notification server a request from a client for information including a change of value;
processing the request for information; and
reporting the change in value to the client using an event mechanism.

2. The method of claim 1, further including controlling the reporting with the event mechanism so that only a change in value is reported to the client.

3. The method of claim 1, further including providing the information to the notification server from a controller.

4. The method of claim 3, wherein the notification server sends and receives the information between the client and the controller.

5. The method of claim 4, wherein the controller is connected to the notification server by way of one of an intranet, extranet, and Internet.

6. The method of claim 5, further comprising utilizing the notification server to send and receive the information using notification services, a notification database, and a notification management subsystem.

7. The method of claim 6, further comprising using the notification database as a relational database configured to track the following information:
(a) current values as reported from source values in the controller;
(b) a list of clients and corresponding information the clients are interested in;
(c) last values reported to each client; and
(d) last time a client requested changed values.

8. The method of claim 6, further comprising utilizing the notification management subsystem to detect additions to the notification database that represent new clients and new sign-ups.

9. The method of claim 6, further comprising utilizing the notification management subsystem to remove clients and respective sign-ups from the notification database.

10. The method of claim 6, further comprising utilizing the notification management subsystem to utilize underlying system services to keep data values updated in the notification database for use by the notification services.

11. The method of claim 6, further comprising using web services as notification services for a client to sign-up for notification and to request changed values.

12. The method of claim 11, further comprising utilizing a sign-up service request to add entries to the notification database, and further comprising using the changed values to execute a SQL query against the notification database to retrieve changed values and format them for return to the client.

13. The method of claim 12, further comprising holding the request open when no changes are present such that the web services do not return immediately to the client, and holding the request open according to a client specified period of time.

14. The method of claim 1, wherein the method is capable of providing rapid screen value updates for client browsers and applications.

15. The method of claim 1, wherein the method is capable of reporting accurate, real-time values to clients.

16. The method of claim 1, further comprising utilizing web services that are implemented by HTTP to send and receive the information.

17. The method of claim 1, wherein the network is a BAS network.

18. A method for reporting a change in value using web services, comprising:
receiving a request from a client for information from a controller including a change in value;
processing the request for information; and
reporting a change in value to the client;
wherein a server utilizes web services that are implemented by HTTP to send and receive the information between the client and the controller, the server comprising notification services, a notification database, and a notification management subsystem.

19. The method of claim 18, wherein only a change in value is reported to the client.

20. The method of claim 18, further comprising utilizing the notification database as a relational database configured to track the following information:
(a) current values as reported from source values in the plurality of controllers;
(b) a list of clients and corresponding information the clients are interested in;
(c) last values reported to each client; and
(d) last time a client requested changed values.

21. The method of claim 18, further comprising utilizing the notification management subsystem to:
(a) detect additions to the notification management database that represent new clients and new sign-ups;
(b) remove clients and their sign-ups from the notification database if the clients time out; and
(c) utilize underlying system services to keep data values updated in the notification database for use by the notification services.

22. The method of claim 18, further comprising the client utilizing web services as notification services to sign-up for notification and to request changed values, using a sign-up service request to add entries to the notification database, and using the request for changed values to execute a SQL query against the notification database to retrieve changed values and format them for return to the client.

23. The method of claim 22, further comprising holding the request open when no changes are present such that the web service does not return immediately to the client, and holding the request open according to a client specified period of time.

24. The method of claim 18, wherein the controller is connected to the server by way of one of an intranet, extranet, and Internet.

25. The method of claim 24, wherein the controller is for a device in a BAS network.

26. The method of claim 25, wherein the change in values represent sensor data.

27. An apparatus for reporting a change in value over a network using web services, comprising:
a notification server configured to receive a request from a client for information including a change in value; and
at least one controller coupled to the notification server by way of a network;
wherein the notification server is further configured to process the request for information and report the change in value to the client, and wherein the notification server utilizes web services that are implemented by HTTP to send and receive the information between the client and the controller.

28. The apparatus of claim 27, wherein the apparatus is capable of rapid screen value updates for client browsers and applications.

29. The apparatus of claim 27, wherein the apparatus is capable of reporting accurate, real-time values to clients.

30. The apparatus of claim 27, wherein only a change in value is reported to a client.

31. The apparatus of claim 27, wherein the server comprises notification services, a notification database, and a notification manager subsystem.

32. The apparatus of claim 31, wherein the notification database is a relational database that is configured to track the following information:
(a) current values as reported from source values in the controller;
(b) a list of clients and corresponding information the clients are interested in;
(c) last values reported to each client; and
(d) last time a client requested changed values.

33. The apparatus of claim 31, wherein the notification management subsystem is configured to detect additions to the notification database that represent new clients and new sign-ups.

34. The apparatus of claim 31, wherein the notification management subsystem is configured to remove clients and their sign-ups from the notification database if the clients have been unused for a pre-determined period of time.

35. The apparatus of claim 31, wherein the notification management subsystem is configured to utilize underlying system services to keep data values updated in the notification database for use by the notification services.

36. The apparatus of claim 31, wherein the notification services are web services which are utilized by the client to sign-up for notification and to request changed values.

37. The apparatus of claim 36, wherein a sign-up service request adds entries to the notification database and the request for changed values executes a SQL query against the notification database to retrieve changed values and format them for return to the client.

38. The apparatus of claim 37, wherein the request is held open when no changes are present such that the web service does not return immediately to the client, and wherein a path is available when a data value does change according to a client specified period of time.
